(19) United States
(12) Patent Application Publication
(10) Pub. No.: US 2023/0400044 A1
(43) Pub. Date: Dec. 14, 2023

(54) VENTURI DEVICES WITH MULTIPLE PORTIONS

(71) Applicant: Rheem Manufacturing Company, Atlanta, GA (US)

(72) Inventors: Harold Gene Havard, JR., Fort Smith, AR (US); Hari Krishna Kanagala, Fort Smith, AR (US); John Rosco Jones, Fort Smith, AR (US)

(21) Appl. No.: 18/207,387

(22) Filed: Jun. 8, 2023

Related U.S. Application Data
(60) Provisional application No. 63/350,921, filed on Jun. 10, 2022.

(51) Int. Cl. F15D 1/02; F24F 13/08

(52) U.S. Cl. CPC F15D 1/025; F24F 13/08

(57) ABSTRACT

The present disclosure provides a venturi system formed of a plurality of venturi portions, each of the plurality of venturi portions having an exterior surface, an interior surface having a generally convex profile, a first end, and a second end, wherein each of the plurality of venturi portions generally forms an arc of a circle and the first end of each of the plurality of venturi portions is configured to attach to the second end of an adjacent venturi portion to form the venturi system, wherein the venturi system is generally circular.

### CROSS-REFERENCE TO RELATED APPLICATION

This application claims the benefit of U.S. Application Ser. No. 63/350,921, filed Jun. 10, 2022, the entirety of which is hereby incorporated by reference.

### FIELD OF THE DISCLOSURE

The present disclosure relates generally to venturi devices and more particularly to venturi devices with multiple portions.

### BACKGROUND

Venturi devices such as venturi rings are important components of heating, ventilation, and air conditioning (HVAC) systems. For example, venturi rings can be installed around an axial fan to improve fan performance.

Traditionally, these venturi rings are manufactured as a single piece. That is, the venturi ring is typically manufactured as a whole ring, even for larger sizes such as 28- and 30-inch diameter venturis. Manufacturing these single-piece venturis, especially at larger sizes, can require larger and increasingly complex and expensive tooling. For example, as the diameter of the venturi increases, larger injection molds can be required. In addition, packing, shipping, and storing single-piece venturis can be space inefficient. The single-piece venturis necessarily require a large amount of space to account for the unused space in the interior of the ring, which can result in high costs relating to packing, shipping, and/or storage. Single-piece venturis also carry a high risk of becoming damaged or broken during packing, shipping, and/or storage due to this unsupported dead space in the interior of the ring.

Therefore, what is needed are improved venturi designs that facilitate simpler and/or cheaper manufacturing and reduced space, costs, and/or risk of damage associated with packing, shipping, and storage for the venturi.

### SUMMARY

The present disclosure relates to venturi devices and more particularly to venturi devices with multiple portions. The disclosed technology includes a venturi system. The venturi system can include a plurality of venturi portions. Each of the plurality of venturi portions can include an exterior surface, an interior surface having a generally convex profile, a first end, and a second end. Each of the plurality of venturi portions can generally form an arc of a circle. The first end of each of the plurality of venturi portions can be configured to attach to the second end of an adjacent venturi portion to form the venturi system. The venturi system can be generally circular.

The first end can include a first flange portion. The second end can include a second flange portion.

The first flange portion can be configured to abut the second flange portion.

The exterior surface can include an outermost edge defining a circumference of the venturi system. The first flange portion and the second flange portion can be located within the circumference of the venturi system.

The first end can include one or more protrusions. The second end can include one or more holes. Each of the one or more holes can be configured to receive a corresponding one of the one or more protrusions.

The first end can include one or more guide holes. The second end can include one or more lead-in holes. The venturi system can include one or more screws. The one or more screws can be configured to attach the first end to the second end by one of the one or more screws extending through a corresponding one of the one or more guide holes and a corresponding one of the one or more lead-in holes.

The first end can include one or more protrusions. The second end can include one or more depressions. The one or more depressions can be configured to at least partially receive a corresponding one of the one or more protrusions to form a snap fit therebetween.

The exterior surface of one of the first and second venturi portions can be configured to nest within the interior surface of the other of the first and second venturi portions such that the plurality of venturi portions are stackable.

The disclosed technology includes a venturi system. The venturi system can include a first portion. The first portion can include a first portion exterior surface, a first portion interior surface having a generally convex profile, a first portion first end, and a first portion second end. The venturi system can include a second portion. The second portion can include a second portion exterior surface, a second portion interior surface having a generally convex profile, a second portion first end, and a second portion second end. The first portion first end can be configured to attach to the second portion second end. The second portion first end can be configured to attach to the first portion second end.

The first portion and the second portion can be substantially identical.

The first portion and second portion can each have a generally semicircular shape such that when the first portion and second portion are attached together, the first portion and second portion form the venturi system. The venturi system can be generally circular.

The first portion first end and second portion first end each can include one or more protrusions. The first portion second end and the second portion second end each can include one or more holes. Each of the one or more holes of the first portion second end can be configured to receive a corresponding one of the one or more protrusions of the second portion first end. Each of the one or more holes of the second portion second end can be configured to receive a corresponding one of the one or more protrusion of the first portion first end.

The first portion first end and second portion first end each can include one or more guide holes. The first portion second end and the second portion second end each can include one or more lead-in holes. The venturi system can include one or more screws configured to attach the first portion to the second portion.

The first portion first end and second portion first end each can include one or more protrusions. The first portion second end and the second portion second end each can include one or more depressions. Each of the one or more depressions of the first portion second end can be configured to at least partially receive a corresponding one of the one or more protrusions of the second portion first end to form a snap fit therebetween. Each of the one or more depressions of the second portion second end can be configured to at least partially receive a corresponding one of the one or more protrusions of the first portion first end to form a snap fit therebetween.

The first portion exterior surface can be configured to nest with the second portion interior surface such that the first portion and second portion are stackable.

The first portion and the second portion each can include one or more tabs configured to attach to one or more protrusions of a heating, ventilation, and air conditioning (HVAC) unit.

The disclosed technology includes a venturi system. The venturi system can include a plurality of venturi portions. Each of the plurality of venturi portions can include an exterior surface, an interior surface, a first end, and a second end. The exterior surface can include an outermost edge. The interior surface can have a generally convex profile. The first end can include a first flange portion. The second end can include a second flange portion. Each of the plurality of venturi portions can generally form an arc of a circle. The first end of each of the plurality of venturi portions can be configured to attach to the second end of an adjacent venturi portion to form the venturi system. The venturi system can be generally circular. The venturi system can have a circumference formed by the outermost edge of the exterior surface. The first flange portion and the second flange portion can be located within the circumference of the venturi system.

The first flange portion can be configured to abut the second flange portion.

The first end can include one or more protrusions. The second end can include one or more holes. Each of the one or more holes can be configured to receive a corresponding one of the one or more protrusions.

The first end can include one or more guide holes. The second end can include one or more lead-in holes. The venturi system can include one or more screws. The one or more screws can be configured to attach the first end to the second end by one of the one or more screws extending through a corresponding one of the one or more guide holes and a corresponding one of the one or more lead-in holes.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features can also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A provides a perspective view of an example venturi device, in accordance with the present disclosure.

FIG. 1B provides a perspective view of a portion of an example venturi device from a first end, in accordance with the present disclosure.

FIG. 1C provides a perspective view of a portion of an example venturi device from a second end, in accordance with the present disclosure.

FIG. 2 provides a top view of a portion of an example venturi device, in accordance with the present disclosure.

FIG. 3A provides a side view of a portion of an example venturi device, in accordance with the present disclosure.

FIG. 3B provides an enlarged side view of a first end of the portion of the example venturi device shown in FIG. 3A, in accordance with the present disclosure.

FIG. 3C provides an enlarged side view of a second end of the portion of the example venturi device shown in FIG. 3A, in accordance with the present disclosure.

FIG. 4A provides an elevation view of a portion of an example venturi device, in accordance with the present disclosure.

FIG. 4B provides an enlarged elevation view of the portion of the example venturi device shown in FIG. 4A, in accordance with the present disclosure.

FIG. 5A provides an inner perspective view of a first end of a portion of an example venturi device, in accordance with the present disclosure.

FIG. 5B provides an outer perspective view of the first end of the portion of the example venturi device shown in FIG. 5A, in accordance with the present disclosure.

FIG. 6A provides an inner perspective view of a second end of a portion of an example venturi device, in accordance with the present disclosure.

FIG. 6B provides an outer perspective view of the second end of the portion of the example venturi device shown in FIG. 6A, in accordance with the present disclosure.

FIG. 6C provides an outer perspective view of the second end of the portion of the example venturi device shown in FIG. 6A, in accordance with the present disclosure.

### DETAILED DESCRIPTION

Throughout this disclosure a venturi device with multiple portions or sections is described. More specifically, the disclosed technology can relate to a venturi device comprising multiple portions, where each portion is the same. As such, the manufacturing of the venturi device can be simplified to manufacturing a plurality of identical portions, each portion being a smaller part than the entire venturi device as a whole. In addition to reduced manufacturing complexity, manufacturing cost, as well as tooling costs (e.g., cost of making tools for manufacture, etc.) may also be reduced as a result of the venture device configuration. The portions can also be packed, shipped, and stored with a smaller footprint than an entire venturi device (e.g., a traditional single-piece venturi device, an assembled venturi device as described herein). For example, the unassembled portions can be stacked or nested. Finally, assembly of the portions into a venturi device can be simplified by each portion being the same. For example, each portion can be interchangeable with any other portion so that a user can assemble the venturi device without needing to match different types of parts together.

While the disclosed technology is described throughout this disclosure in relation to a venturi device for heating, ventilation, and air condition (HVAC) systems, those having skill in the art will recognize that the disclosed technology is not so limited and can be applicable to other scenarios and applications. For example, it is contemplated that the disclosed technology can be applicable to any venturi device, such as venturi rings and venturi devices provided with a fan. Moreover, a venturi device as disclosed herein that is provided with a fan is not limited to any specific fan types and can include axial fans and centrifugal fans as non-limiting examples. In addition, the disclosed venturi device can be used with any system such as refrigeration systems, industrial ventilation systems, and the like.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Indeed, it is to be understood that other examples are contemplated. Many suitable components that would perform the same or similar functions as components described herein are intended to be embraced within the scope of the disclosed devices and methods. Such other components not described herein may include, but are not limited to, for example, components developed after development of the disclosed technology.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified. Further, it is contemplated that the disclosed methods and processes can include, but do not necessarily include, all steps discussed herein. That is, methods and processes in accordance with the disclosed technology can include some of the disclosed while omitting others.

Throughout the specification and the claims, the following terms take at least the meanings explicitly associated herein, unless otherwise indicated. The term “or” is intended to mean an inclusive “or.” Further, the terms “a,” “an,” and “the” are intended to mean one or more unless specified otherwise or clear from the context to be directed to a singular form. By “comprising,” “containing,” or “including” it is meant that at least the named element, or method step is present in article or method, but does not exclude the presence of other elements or method steps, even if the other such elements or method steps have the same function as what is named.

As used herein, unless otherwise specified, the use of the ordinal adjectives “first,” “second,” “third,” etc., to describe a common object, merely indicate that different instances of like objects are being discussed and are not intended to imply that the objects so described must be in a given sequence, either temporally, spatially, in ranking, or in any other manner.

Although the disclosed technology may be described herein with respect to various systems and methods, it is contemplated that embodiments or implementations of the disclosed technology with identical or substantially similar features may alternatively be implemented as methods or systems. For example, any aspects, elements, features, or the like described herein with respect to a method can be equally attributable to a system. As another example, any aspects, elements, features, or the like described herein with respect to a system can be equally attributable to a method.

To facilitate an understanding of the principles and features of the present disclosure, various examples of the disclosed technology are explained herein. Reference is made in detail herein to the disclosed technology, examples of which are illustrated in the accompanying drawings and disclosed herein. Wherever convenient, the same reference numbers will be used throughout the drawings to refer to the same or like parts. The components, steps, and materials described herein as making up various elements of the disclosed technology are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Referring now to the drawings, in which like numerals represent like elements, examples of the present disclosure are herein described. As will be described in greater detail, the present disclosure can include venturi systems and more particularly to venturi systems with multiple portions or sections.

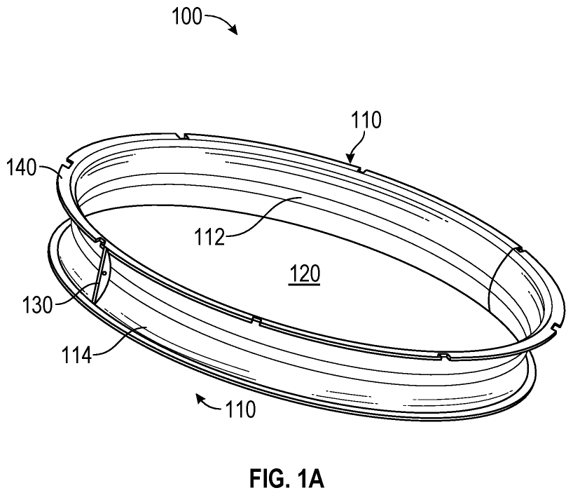

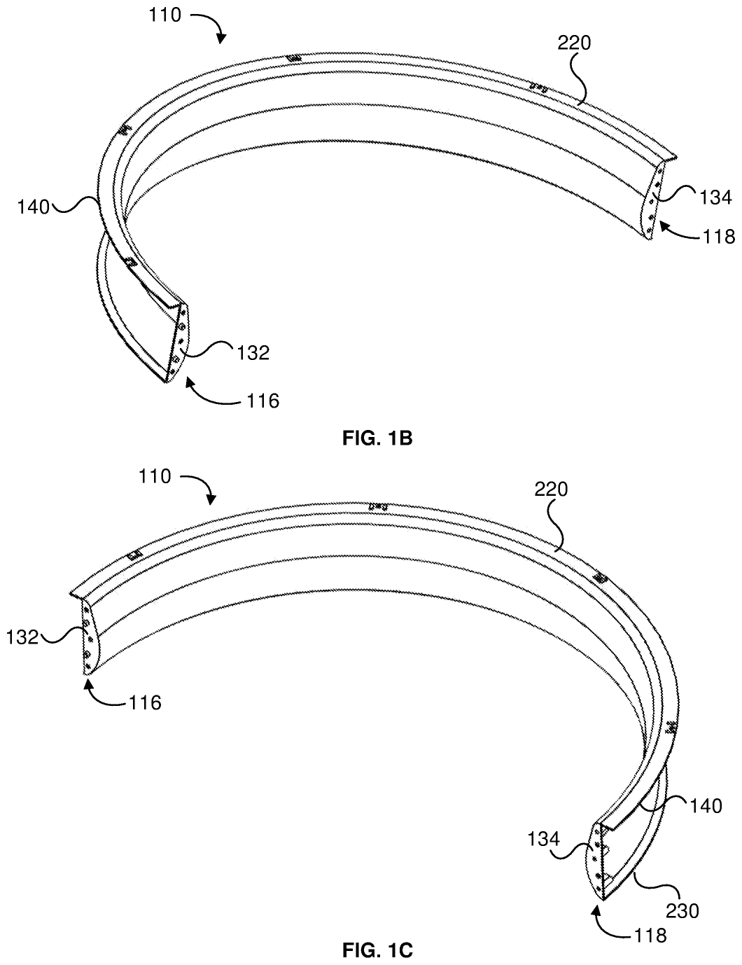

As shown in FIG. 1A, the disclosed technology includes a venturi device 100. The venturi device 100 can include a plurality of venturi portions 110. For example, the venturi device 100 can include a first portion and a second portion. The various venturi portions 110 can each be the same part (e.g., the venturi device 100 can be made up of a plurality of the same part). That is to say, each venturi portion 110 can have the same dimensions, geometries, and/or be made of the same material. While the venturi device 100 is illustrated as having two venturi portions 110, the venturi device 100 can alternatively include three, four, five, or more venturi portions, as explained herein.

As illustrated in FIG. 1A, the venturi device 100 can be generally circular in shape, such as an open cylinder defining interior 120. The interior 120 can be an opening in the venturi device configured to allow a fluid to pass through the venturi device 100. For example, the fluid can flow through the interior 120 in a flow path that is generally perpendicular to the circular profile of the venturi device 100. The venturi device 100 can have an interior surface 112 and an exterior surface 114. The interior surface 112 can include a profile configured to create a venturi effect as a fluid passes through the interior 120 of the venturi device 100, as explained more fully herein. The venturi device 100 can include a plurality of venturi portions 110, as explained more fully herein. For example, the venturi device 100 can have two venturi portions 110. The venturi device 100 can have one or more flanged connections 130. For example, the venturi device 100 can have a flange connection 130 configured to connect adjacent venturi portions 110.

The exterior surface 114 can include an outermost edge 140. The outermost edge 140 can define the outermost points of the venturi system 100, for example, the outer circumference of the venturi system 100. As illustrated in FIGS. 1A, 1B, and 1C, the outermost edge 140 can be a single edge located at an end of the exterior surface 114. For example, an outermost edge 140 can located at either end of the exterior surface 114 (e.g., at the top end 220 and/or at the bottom end 230 such as is shown in FIG. 1C). Alternatively, the outermost edge 140 can be a plurality of edges located at the same outermost points. For example, the outermost edge 140 can located at both ends of the exterior surface 114 (e.g., at the top end 220 and at the bottom end 230) such that outermost points of both ends align and define the outer circumference of the venturi system 100.

As illustrated in FIGS. 1B and 1C, the venturi portion 110 can be semicircular in shape. Alternatively, the venturi portion 110 can have a shape that is an arc of a circle. For example, the venturi portion 110 can be any size arc of a circle wherein the circle is divisible by the arc. Stated otherwise, the arc of a given venturi portion 110 can correspond to an angle equal to 360 degrees divided by the number of venturi portions 110 used to assemble the venturi device 100. For example, the venturi portion 110 can correspond to a 90-degree arc when four venturi portions 110 are used to form the circular venturi device 100. As illustrated in FIGS. 1B and 1C, the venturi portion 110 can include a first end 116 and a second end 118.

As illustrated in FIGS. 1B and 1C, the venturi portion 110 can include a first flange portion 132 and a second flange portion 134. The first flange portion 132 can be located at the first end 116. The second flange portion 134 can be located at the second end 118. The first flange portion 132 and the second flange portion 134 can be configured to abut one another to create a flange connection 130. For example, a surface of the first flange portion 132 can be configured to sit flush against a surface of the second flange portion 134 to create a flange connection. Alternatively, or in addition, a surface of the first flange portion 132 can be configured to be adjacent to a surface of the second flange portion 134 to create a flange connection 130. The flange connection 130 can be further defined by fastening systems located at the first and second ends 116, 118, as explained more fully herein. The first flange portion 132 and/or the second flange portion 134 can be located within outermost edge 140 of the venturi system. For example, the first flange portion 132 and/or the second flange portion 134 can be located within the circumference of the venturi system. That is to say, the first flange portion 132 and/or the second flange portion 134 can have an outermost point that has a radial distance (measured radially outward from a central axis of the assembled venturi device 100) that is less than the radial distance of the outermost edge 140. Alternatively, the first flange portion 132 and the second flange portion 134 can be configured such that no portion of the first flange portion 132 and the second flange portion 134 extends outside the outermost edge 140.

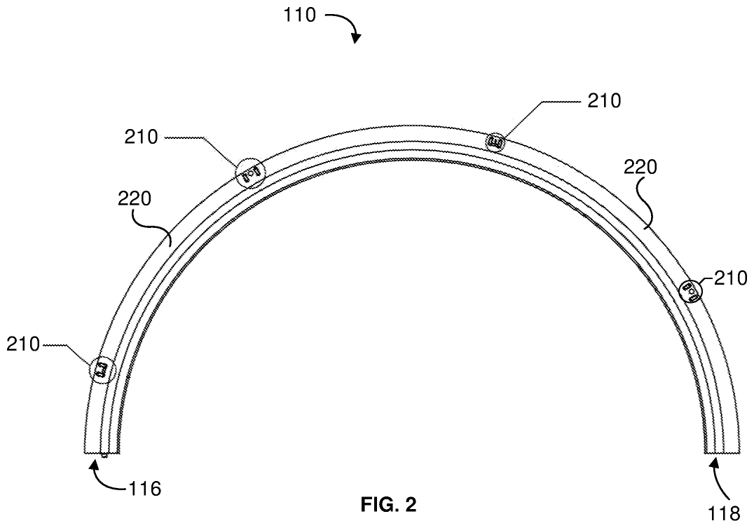

As illustrated in FIG. 2, the venturi portion 110 can include one or more tabs 210. The tabs 210 can be located on a top end 220 of the venturi portion 110. The tabs 210 can include a protrusion. The protrusion can be configured to mate with a hole located on a device to which the venturi device is designed to attach to (e.g., an HVAC unit). Alternatively, or in addition, the venturi portion 110 can include one or more holes. For example, a hole can be configured to at least partially receive a protrusion or tab located on a device to which the venturi device is designed to attach (e.g., an HVAC unit). Alternatively, or in addition, the hole can be configured to align with another hole (e.g., a threaded insert) on the device (e.g., HVAC unit) to enable the venturi device 100 to be attached to the device by fasteners, such as screws, bolts, or the like. Alternatively, or in addition, the hole can be threaded. The holes and/or protrusions of the tabs 210 on the venturi portion 110 and the holes and/or protrusions on the device (e.g., HVAC unit) can be configured to mate, thereby creating a loose fit, a press fit, or a snap fit, as non-limiting examples. The holes and/or protrusions of the tabs 210 on the venturi portion 110 and the holes and/or protrusions on the device can be arranged such that mating the holes and/or tabs 210 can cause the venturi device 100 to become properly oriented relative to the device (e.g., by aligning the protrusions and holes the venturi device 100 is self-locating). Alternatively, or in addition, the tabs 210 can include or be configured to interface with any attachment system known in the art, including, but not limited to, screws, bolts, nails, adhesive, hook and loop, snap and button, welding, and the like, or any combination thereof.

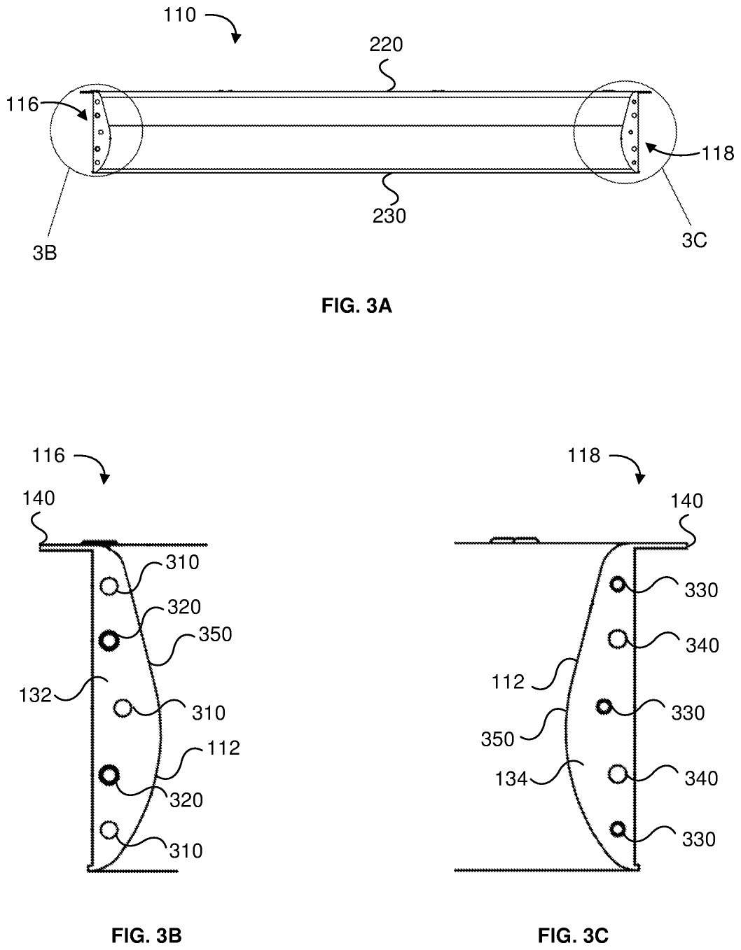

As shown in FIGS. 3A and 3B, the first end 116 can include one or more holes 310. As illustrated, the first end 116 can include three holes 310, but the disclosed technology is not so limited and can include one, two, four, or more holes. The holes 310 can be configured to receive a screw or bolt. For example, the holes 310 can be a guide hole. The holes 310 can be configured to allow a screw to pass through the holes 310 and prevent the head of the screw from passing therethrough. As such, the screw can be used to attach the first end 116 to the second end 118, as explained more fully herein. Alternatively, or in addition, the first end 116 can include one or more protrusions 320. As illustrated in FIG. 3B, the first end 116 can include two protrusions 320, although any number of protrusions is contemplated. The protrusions 320 can be configured to mate with alignment holes 340 of the second end 118, as explained more fully herein.

The second end 118 can include one or more lead-in holes 330. As illustrated in FIG. 3C, the second end can include three lead-in holes 330, but the disclosed technology is not so limited and can include one, two, four, or more lead-in holes. The lead-in holes can be configured to receive a screw or bolt. For example, the lead-in hole 330 can be a threaded insert. As such, the screw can be used to attach the second end 118 to the first end 116 by threading the screw through the holes 310 and into the lead-in hole 330 (e.g., a threaded hole). Alternatively, or in addition, the second end 118 can include one or more alignment holes 340. As illustrated in FIG. 3C, the second end 118 can include two alignment holes 340, although any number of alignment holes is contemplated. The alignment holes 340 can be configured to mate with the protrusions 320 such that each protrusion is configured to align with, and at least partially insert into, a corresponding alignment hole 340. The protrusions 320 and alignment holes 340 can be configured to create a loose fit, a press fit, or a snap fit, as non-limiting examples. The protrusions 320 and alignment holes 340 can help align the first end 116 and the second end 118 to facilitate easy assembly of the venturi device 100. For example, when the protrusions 320 mate with the alignment holes 340, the attachment portions can also be aligned (e.g., the holes 310 and lead-in holes 330 can become aligned to enable easy attachment of the two ends 116, 118, snap fit portions can become aligned). As such, by aligning the protrusions 320 and alignment holes 340, the first end 116 of a first venturi portion 110 and the second end 118 of a second venturi portion 110 can be considered self-locating for attachment to one another.

Alternatively, or in addition, the first end 116 and the second end 118 can be attached through snaps. For example, the first end 116 can include one or more protrusions and the second end 118 can include one or more depressions or recesses configured to mate with the one or more protrusions. The one or more protrusions can be configured to snap into the one or more depressions creating a snap fit (e.g., the protrusion can plastically deform as the first end 116 and second end 118 are attached). Alternatively, or in addition, the first end 116 can be attached to the second end 118 by any attachment system known in the art, including, but not limited to, screws, bolts, nails, adhesive, hook and loop, snap and button, welding, and the like, or any combination thereof.

The interior surface 112 can include a venturi profile 350 configured to reduce the cross sectional area of the interior 120 of the venturi device 100. For example, as illustrated in FIGS. 3B and 3C, the venturi profile 350 (i.e., the inner wall or interior surface 112 of the venturi portion 110 and the venturi device 100) can be generally convex in shape. The venturi profile 350 can be asymmetrical. For example, the peak of the convex shape of the venturi profile 350 (i.e., the most radially inward portion of the inner wall or interior surface 112 of the venturi portion 110 and the venturi device 100) can be located nearer the bottom of the venturi portion 110 and the venturi device 100 than the top of the venturi portion 110 and the venturi device 100. The venturi profile 350 can be configured to create a venturi effect on fluids passing through the interior 120 of the venturi device 100 by limiting the cross sectional area through which the fluid can pass. For example, the venturi profile 350 can be continuous around the entire interior surface 112 of the venturi device 100. As such, as the venturi profile 350 extends into the interior 120, the cross-sectional area of the interior 120 of the venturi device 100 is reduced. Alternatively, or in addition, the exterior surface 114 can have a generally concave shape. For example, the exterior surface 114 can have a shape that generally follows the shape of the interior surface 112 (e.g., the thickness of the wall of the venturi device 100 that forms the interior surface 112 and exterior surface 114 can remain generally constant). As will be appreciated, this can reduce on the amount of material required to form the venturi portion 110.

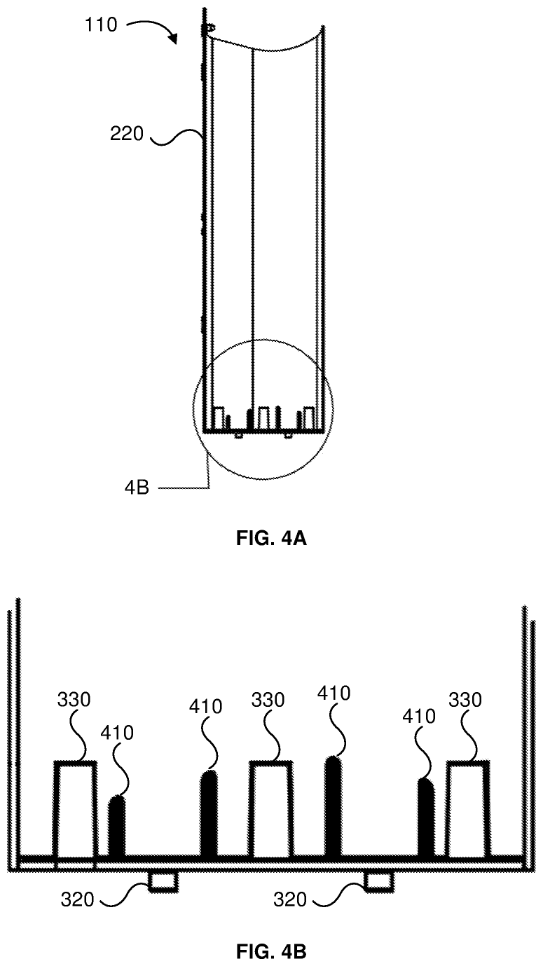

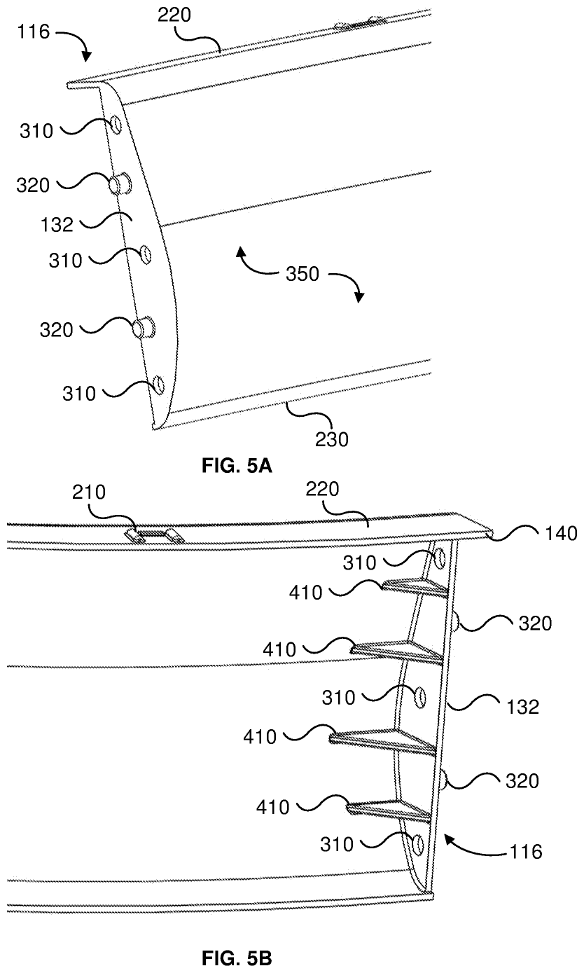

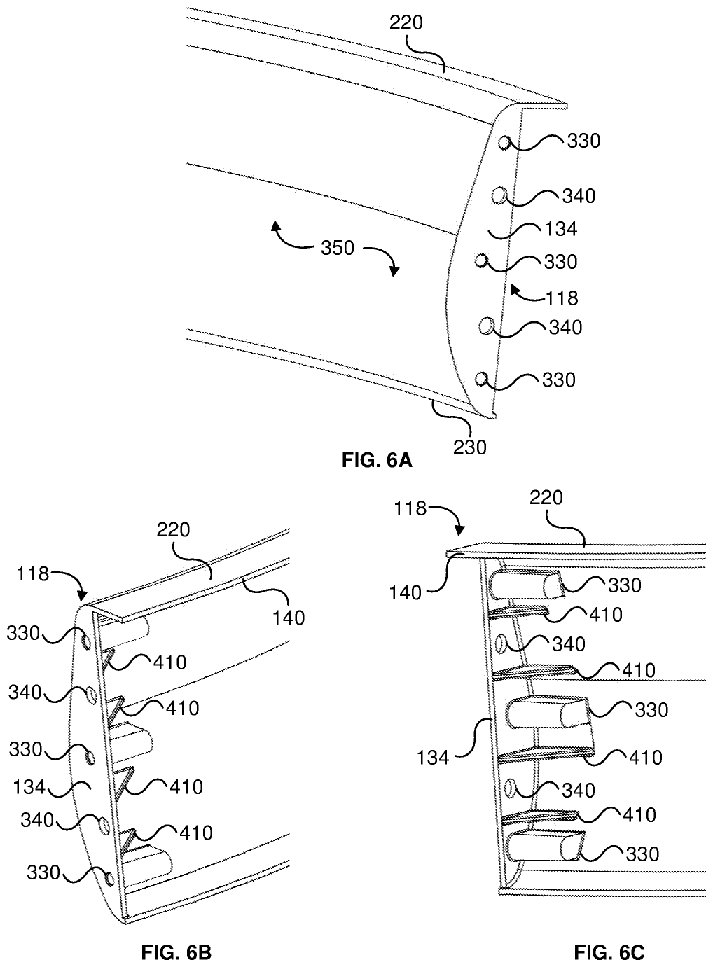

The first end 116 and/or the second end 118 can include one or more braces or supports 410. For example, as illustrated in FIGS. 4B, 5B, 6B, and 6C, the first end 116 and/or the second end 118 can include four supports 410. The supports 410 can be angled support members configured to support the first end 116 and the second end 118 from the exterior surface 114. As such, the supports 410 can allow the ends 116, 118 to withstand additional forces when attached to one another (e.g., to prevent excessive twisting or flexing at the joint between two adjacent venturi portions 110).

The venturi device 100 can be formed of one or more plastics. For example, the venturi portions 110 can be injection molded using a plastic. Alternatively, or in addition, the venturi device 100 can be formed of one or more metals (e.g., aluminum).

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A venturi system comprising a plurality of venturi portions, each of the plurality of venturi portions comprising:
an exterior surface;
an interior surface having a generally convex profile;
a first end; and
a second end,
wherein each of the plurality of venturi portions generally forms an arc of a circle and the first end of each of the plurality of venturi portions is configured to attach to the second end of an adjacent venturi portion to form the venturi system, wherein the venturi system is generally circular.

2. The venturi system of claim 1, wherein the first end comprises a first flange portion and the second end comprises a second flange portion.

3. The venturi system of claim 2, wherein the first flange portion is configured to abut the second flange portion.

4. The venturi system of claim 2, wherein the exterior surface comprises an outermost edge defining a circumference of the venturi system and wherein the first flange portion and the second flange portion are located within the circumference of the venturi system.

5. The venturi system of claim 1, wherein the first end comprises one or more protrusions, the second end comprises one or more holes, and each of the one or more holes is configured to receive a corresponding one of the one or more protrusions.

6. The venturi system of claim 1, wherein the first end comprises one or more guide holes, the second end comprises one or more lead-in holes, and the venturi system further comprises one or more screws configured to attach the first end to the second end by one of the one or more screws extending through a corresponding one of the one or more guide holes and a corresponding one of the one or more lead-in holes.

7. The venturi system of claim 1, wherein the first end comprises one or more protrusions, the second end comprises one or more depressions configured to at least partially receive a corresponding one of the one or more protrusions to form a snap fit therebetween.

8. The venturi system of claim 1, wherein the exterior surface of one of the plurality of venturi portions is configured to nest within the interior surface of one of the other plurality of venturi portions such that the plurality of venturi portions are stackable.

9. A venturi system comprising:
a first portion comprising:
a first portion exterior surface;
a first portion interior surface having a generally convex profile;
a first portion first end; and
a first portion second end; and
a second portion comprising:
a second portion exterior surface;
a second portion interior surface having a generally convex profile;
a second portion first end; and
a second portion second end,
wherein the first portion first end is configured to attach to the second portion second end and the second portion first end is configured to attach to the first portion second end.

10. The venturi system of claim 9, wherein the first portion and the second portion are substantially identical.

11. The venturi system of claim 9, wherein the first portion and second portion each have a generally semicircular shape such that when the first portion and second portion are attached together, the first portion and second portion form the venturi system, the venturi system being generally circular.

12. The venturi system of claim 9, wherein:
the first portion first end and second portion first end each comprise one or more protrusions,
the first portion second end and the second portion second end each comprise one or more holes,
each of the one or more holes of the first portion second end is configured to receive a corresponding one of the one or more protrusions of the second portion first end, and
each of the one or more holes of the second portion second end is configured to receive a corresponding one of the one or more protrusion of the first portion first end.

13. The venturi system of claim 9, wherein:
the first portion first end and second portion first end each comprise one or more guide holes,
the first portion second end and the second portion second end each comprise one or more lead-in holes, and
the venturi system further comprises one or more screws configured to attach the first portion to the second portion.

14. The venturi system of claim 9, wherein:
the first portion first end and second portion first end each comprise one or more protrusions,
the first portion second end and the second portion second end each comprise one or more depressions,
each of the one or more depressions of the first portion second end is configured to at least partially receive a corresponding one of the one or more protrusions of the second portion first end to form a snap fit therebetween, and
each of the one or more depressions of the second portion second end is configured to at least partially receive a corresponding one of the one or more protrusions of the first portion first end to form a snap fit therebetween.

15. The venturi system of claim 9, wherein the first portion exterior surface is configured to nest with the second portion interior surface such that the first portion and second portion are stackable.

16. The venturi system of claim 9, wherein the first portion and the second portion each further comprise one or more tabs configured to attach to one or more protrusions of a heating, ventilation, and air conditioning (HVAC) unit.

17. A venturi system comprising a plurality of venturi portions, each of the plurality of venturi portions comprising:
an exterior surface comprising an outermost edge;
an interior surface having a generally convex profile;
a first end comprising a first flange portion; and
a second end comprising a second flange portion,
wherein each of the plurality of venturi portions generally forms an arc of a circle and the first end of each of the plurality of venturi portions is configured to attach to the second end of an adjacent venturi portion to form the venturi system, wherein the venturi system is generally circular having a circumference formed by the outermost edge of the exterior surface, and
wherein the first flange portion and the second flange portion are located within the circumference of the venturi system.

18. The venturi system of claim 17, wherein the first flange portion is configured to abut the second flange portion.

19. The venturi system of claim 17, wherein the first end comprises one or more protrusions, the second end comprises one or more holes, and each of the one or more holes is configured to receive a corresponding one of the one or more protrusions.

20. The venturi system of claim 17, wherein the first end comprises one or more guide holes, the second end comprises one or more lead-in holes, and the venturi system further comprises one or more screws configured to attach the first end to the second end by one of the one or more screws extending through a corresponding one of the one or more guide holes and a corresponding one of the one or more lead-in holes.
